(19) United States
(12) Patent Application Publication
(10) Pub. No.: US 2021/0078597 A1
(43) Pub. Date: Mar. 18, 2021

(54) METHOD AND APPARATUS FOR DETERMINING AN ORIENTATION OF A TARGET OBJECT, METHOD AND APPARATUS FOR CONTROLLING INTELLIGENT DRIVING CONTROL, AND DEVICE

(71) Applicant: Beijing SenseTime Technology Development Co., Ltd., Beijing (CN)

(72) Inventors: Yingjie CAI, Beijing (CN); Shinan LIU, Beijing (CN); Xingyu ZENG, Beijing (CN)

(21) Appl. No.: 17/106,912

(22) Filed: Nov. 30, 2020

Related U.S. Application Data
(63) Continuation of application No. PCT/CN2019/119124, filed on Nov. 18, 2019.

(30) Foreign Application Priority Data
May 31, 2019 (CN) 201910470314.0

(51) Int. Cl. B60W 60/00; G06T 7/73; G06T 7/11; G06T 7/50

(52) U.S. Cl. CPC B60W 60/0016; G06T 7/73; G06T 7/11; G06T 7/50; B60W 2420/42; G06T 2207/10016; G06T 2207/20084; G06T 2207/10028; G06T 2207/30252

(57) ABSTRACT

Provided are a method and apparatus for determining an orientation of a target object, a method and apparatus for controlling intelligent driving, an electronic device, a computer-readable storage medium and a computer program. The method for determining an orientation of a target object includes that: a visible surface of a target object in an image is acquired; position information of multiple points in the visible surface in a horizontal plane of a Three-Dimensional (3D) space is acquired; and an orientation of the target object is determined based on the position information.

### CROSS-REFERENCE TO RELATED APPLICATION

This application is a continuation of International Patent Application No. PCT/CN2019/119124, filed on Nov. 18, 2019, which claims priority to China Patent Application No. 201910470314.0, filed to the National Intellectual Property Administration of the People's Republic of China on May 31, 2019 and entitled “Method and Apparatus for Determining an Orientation of a Target Object, Method and Apparatus for Controlling Intelligent Driving, and Device”. The disclosures of International Patent Application No. PCT/CN2019/119124 and China Patent Application No. 201910470314.0 are hereby incorporated by reference in their entireties.

### TECHNICAL FIELD

The disclosure relates to a computer vision technology, and particularly to a method for determining an orientation of a target object, an apparatus for determining an orientation of a target object, a method for controlling intelligent driving, an apparatus for controlling intelligent driving, an electronic device, a computer-readable storage medium and a computer program.

### BACKGROUND

A visual perception technology typically is determining an orientation of a target object such as a vehicle, other transportation means and a pedestrian is an important content in. For example, in an application scenario with a relatively complex road condition, accurately determining an orientation of a vehicle is favorable for avoiding a traffic accident and further favorable for improving the intelligent driving safety of the vehicle.

### SUMMARY

According to a first aspect of the implementation modes of the disclosure, a method for determining an orientation of a target object is provided, which may include that: a visible surface of a target object in an image is acquired; position information of multiple points in the visible surface in a horizontal plane of a Three-Dimensional (3D) space is acquired; and an orientation of the target object is determined based on the position information.

According to a second aspect of the implementation modes of the disclosure, a method for controlling intelligent driving is provided, which may include that: a video stream of a road where a vehicle is acquired through a photographic device arranged on the vehicle; processing of determining an orientation of a target object is performed on at least one video frame in the video stream by use of the above method for determining an orientation of a target object to obtain the orientation of the target object; and a control instruction for the vehicle is generated and output based on the orientation of the target object.

According to a third aspect of the implementation modes of the disclosure, an apparatus for determining an orientation of a target object is provided, which may include: a first acquisition module, configured to acquire a visible surface of a target object in an image; a second acquisition module, configured to acquire position information of multiple points in the visible surface in a horizontal plane of a 3D space; and a determination module, configured to determine an orientation of the target object based on the position information.

According to a fourth aspect of the implementation modes of the disclosure, an apparatus for controlling intelligent driving is provided, which may include: a third acquisition module, configured to acquire a video stream of a road where a vehicle is through a photographic device arranged on the vehicle; the above apparatus for determining an orientation of a target object, configured to perform processing of determining an orientation of a target object on at least one video frame in the video stream to obtain the orientation of the target object; and a control module, configured to generate and output a control instruction for the vehicle based on the orientation of the target object.

According to a fifth aspect of the implementation modes of the disclosure, an electronic device is provided, which may include: a memory, configured to store a computer program; and a processor, configured to execute the computer program stored in the memory, the computer program being executed to implement any method implementation mode of the disclosure.

According to a sixth aspect of the implementation modes of the disclosure, a computer-readable storage medium is provided, in which a computer program may be stored, the computer program being executed by a processor to implement any method implementation mode of the disclosure.

According to a seventh aspect of the implementation modes of the disclosure, a computer program is provided, which may include computer instructions, the computer instructions running in a processor of a device to implement any method implementation mode of the disclosure.

The technical solutions of the disclosure will further be described below through the drawings and the implementation modes in detail.

### BRIEF DESCRIPTION OF THE DRAWINGS

The drawings forming a part of the specification describe the implementation modes of the disclosure and, together with the descriptions, are adopted to explain the principle of the disclosure.

Referring to the drawings, the disclosure may be understood more clearly according to the following detailed descriptions.

FIG. 1 is a flowchart of an implementation mode of a method for determining an orientation of a target object according to the disclosure.

FIG. 2 is a schematic diagram of obtaining a visible surface of a target object in an image according to the disclosure.

FIG. 3 is a schematic diagram of an effective region of a vehicle front-side surface according to the disclosure.

FIG. 4 is a schematic diagram of an effective region of a vehicle rear-side surface according to the disclosure.

FIG. 5 is a schematic diagram of an effective region of a vehicle left-side surface according to the disclosure.

FIG. 6 is a schematic diagram of an effective region of a vehicle right-side surface according to the disclosure.

FIG. 7 is a schematic diagram of a position box configured to select an effective region of a vehicle front-side surface according to the disclosure.

FIG. 8 is a schematic diagram of a position box configured to select an effective region of a vehicle right-side surface according to the disclosure.

FIG. 9 is a schematic diagram of an effective region of a vehicle rear-side surface according to the disclosure.

FIG. 10 is a schematic diagram of a depth map according to the disclosure.

FIG. 11 is a schematic diagram of a points selection region of an effective region according to the disclosure.

FIG. 12 is a schematic diagram of straight line fitting according to the disclosure.

FIG. 13 is a flowchart of an implementation mode of a method for controlling intelligent driving according to the disclosure.

FIG. 14 is a structure diagram of an implementation mode of an apparatus for determining an orientation of a target object according to the disclosure.

FIG. 15 is a structure diagram of an implementation mode of an apparatus for controlling intelligent driving according to the disclosure.

FIG. 16 is a block diagram of an exemplary device implementing an implementation mode of the disclosure.

### DETAILED DESCRIPTION

Each exemplary embodiment of the disclosure will now be described with reference to the drawings in detail. It is to be noted that relative arrangement of components and operations, numeric expressions and numeric values elaborated in these embodiments do not limit the scope of the disclosure, unless otherwise specifically described.

In addition, it is to be understood that, for convenient description, the size of each part shown in the drawings is not drawn in practical proportion. The following descriptions of at least one exemplary embodiment are only illustrative in fact and not intended to form any limit to the disclosure and application or use thereof.

Technologies, methods and devices known to those of ordinary skill in the art may not be discussed in detail, but the technologies, the methods and the devices should be considered as a part of the specification as appropriate.

It is to be noted that similar reference signs and letters represent similar terms in the following drawings, and thus a certain term, once defined in a drawing, is not required to be further discussed in subsequent drawings.

The embodiments of the disclosure may be applied to an electronic device such as a terminal device, a computer system and a server, which may be operated together with numerous other universal or dedicated computing system environments or configurations. Examples of well-known terminal device computing systems, environments and/or configurations suitable for use together with an electronic device such as a terminal device, a computer system and a server include, but not limited to, a Personal Computer (PC) system, a server computer system, a thin client, a thick client, a handheld or laptop device, a microprocessor-based system, a set-top box, a programmable consumer electronic product, a network PC, a microcomputer system, a large computer system, a distributed cloud computing technical environment including any abovementioned system, and the like.

The electronic device such as a terminal device, a computer system and a server may be described in a general context with executable computer system instruction (for example, a program module) being executed by a computer system. Under a normal condition, the program module may include a routine, a program, a target program, a component, a logic, a data structure and the like, which may execute specific tasks or implement specific abstract data types. The computer system/server may be implemented in a distributed cloud computing environment, and in the distributed cloud computing environment, tasks may be executed by a remote processing device connected through a communication network. In the distributed cloud computing environment, the program module may be in a storage medium of a local or remote computer system including a storage device.

### Exemplary Embodiment

A method for determining an orientation of a target object of the disclosure may be applied to multiple applications such as vehicle orientation detection, 3D target object detection and vehicle trajectory fitting. For example, for each video frame in a video, an orientation of each vehicle in each video frame may be determined by use of the method of the disclosure. For another example, for any video frame in a video, an orientation of a target object in the video frame may be determined by use of the method of the disclosure, thereby obtaining a position and scale of the target object in the video frame in a 3D space on the basis of obtaining the orientation of the target object to implement 3D detection. For another example, for multiple continuous video frames in a video, orientations of the same vehicle in the multiple video frames may be determined by use of the method of the disclosure, thereby fitting a running trajectory of the vehicle based on the multiple orientations of the same vehicle.

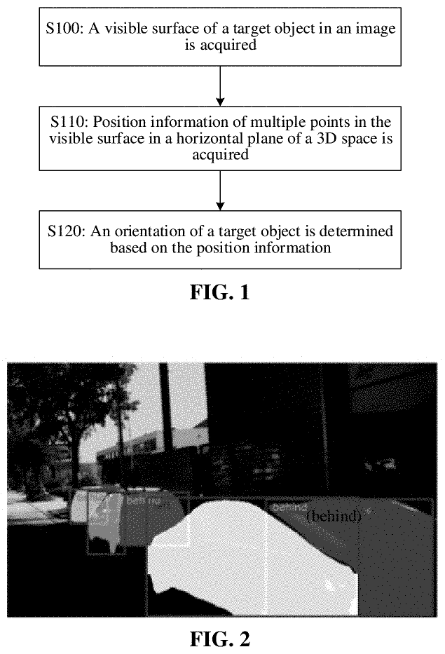

FIG. 1 is a flowchart of an embodiment of a method for determining an orientation of a target object according to the disclosure. As shown in FIG. 1, the method of the embodiment includes S100, S110 and S120. Each operation will be described below in detail.

In S100, a visible surface of a target object in an image is acquired.

In an optional example, the image in the disclosure may be a picture, a photo, a video frame in a video and the like. For example, the image may be a video frame in a video shot by a photographic device arranged on a movable object. For another example, the image may be a video frame in a video shot by a photographic device arranged at a fixed position. The movable object may include, but not limited to, a vehicle, a robot or a mechanical arm, etc. The fixed position may include, but not limited to, a road, a desktop, a wall or a roadside, etc.

In an optional example, the image in the disclosure may be an image obtained by a general high-definition photographic device (for example, an Infrared Ray (IR) camera or a Red Green Blue (RGB) camera), so that the disclosure is favorable for avoiding high implementation cost and the like caused by necessary use of high-configuration hardware such as a radar range unit and a depth photographic device.

In an optional example, the target object in the disclosure includes, but not limited to, a target object with a rigid structure such as a transportation means. The transportation means usually includes a vehicle. The vehicle in the disclosure includes, but not limited to, a motor vehicle with more than two wheels (not including two wheels), a non-power-driven vehicle with more than two wheels (not including two wheels) and the like. The motor vehicle with more than two wheels includes, but not limited to, a four-wheel motor vehicle, a bus, a truck or a special operating vehicle, etc. The non-power-driven vehicle with more than two wheels includes, but not limited to, a man-drawn tricycle, etc. The target object in the disclosure may be of multiple forms, so that improvement of the universality of a target object orientation determination technology of the disclosure is facilitated.

In an optional example, the target object in the disclosure usually includes at least one surface. For example, the target object usually includes four surfaces, i.e., a front-side surface, a rear-side surface, a left-side surface and a right-side surface. For another example, the target object may include six surfaces, i.e., a front-side upper surface, a front-side lower surface, a rear-side upper surface, a rear-side lower surface, a left-side surface and a right-side surface. The surfaces of the target object may be preset, namely ranges and number of the surfaces are preset.

In an optional example, when the target object is a vehicle, the target object may include a vehicle front-side surface, a vehicle rear-side surface, a vehicle left-side surface and a vehicle right-side surface. The vehicle front-side surface may include a front side of a vehicle roof, a front side of a vehicle headlight and a front side of a vehicle chassis. The vehicle rear-side surface may include a rear side of the vehicle roof, a rear side of a vehicle tail light and a rear side of the vehicle chassis. The vehicle left-side surface may include a left side of the vehicle roof, left-side surfaces of the vehicle headlight and the vehicle tail light, a left side of the vehicle chassis and vehicle left-side tires. The vehicle right-side surface may include a right side of the vehicle roof, right-side surfaces of the vehicle headlight and the vehicle tail light, a right side of the vehicle chassis and vehicle right-side tires.

In an optional example, when the target object is a vehicle, the target object may include a vehicle front-side upper surface, a vehicle front-side lower surface, a vehicle rear-side upper surface, a vehicle rear-side lower surface, a vehicle left-side surface and a vehicle right-side surface. The vehicle front-side upper surface may include a front side of a vehicle roof and an upper end of a front side of a vehicle headlight. The vehicle front-side lower surface may include an upper end of a front side of a vehicle headlight and a front side of a vehicle chassis. The vehicle rear-side upper surface may include a rear side of the vehicle roof and an upper end of a rear side of a vehicle tail light. The vehicle rear-side lower surface may include an upper end of the rear side of the vehicle tail light and a rear side of the vehicle chassis. The vehicle left-side surface may include a left side of the vehicle roof, left-side surfaces of the vehicle headlight and the vehicle tail light, a left side of the vehicle chassis and vehicle left-side tires. The vehicle right-side surface may include a right side of the vehicle roof, right-side surfaces of the vehicle headlight and the vehicle tail light, a right side of the vehicle chassis and vehicle right-side tires.

In an optional example, the visible surface of the target object in the image may be obtained in an image segmentation manner in the disclosure. For example, semantic segmentation may be performed on the image by taking a surface of the target object as a unit, thereby obtaining all visible surfaces of the target object (for example, all visible surfaces of the vehicle) in the image based on a semantic segmentation result. When the image includes multiple target objects, all visible surfaces of each target object in the image may be obtained in the disclosure.

For example, in FIG. 2, visible surfaces of three target objects in the image may be obtained in the disclosure. The visible surfaces of each target object in the image shown in FIG. 2 are represented in a mask manner A first target object in the image shown in FIG. 2 is a vehicle at a right lower part of the image, and visible surfaces of the first target object include a vehicle rear-side surface (as shown by a dark gray mask of the vehicle on the rightmost side in FIG. 2) and a vehicle left-side surface (as shown by a light gray mask of the vehicle on the rightmost side in FIG. 2). A second target object in the image shown in FIG. 2 is above a left part of the first target object, and visible surfaces of the second target object include a vehicle rear-side surface (as shown by a dark gray mask of a middle vehicle in FIG. 2) and a vehicle left-side surface (as shown by a gray mask of the middle vehicle in FIG. 2). A third target object in FIG. 2 is above a left part of the second target object, and a visible surface of the third target object includes a vehicle rear-side surface (as shown by a light gray mask of a vehicle on the leftmost side in FIG. 2).

In an optional example, a visible surface of a target object in the image may be obtained by use of a neural network in the disclosure. For example, an image may be input to a neural network, semantic segmentation may be performed on the image through the neural network (for example, the neural network extracts feature information of the image at first, and then the neural network performs classification and regression on the extracted feature information), and the neural network may generate and output multiple confidences for each visible surface of each target object in the input image. A confidence represents a probability that the visible surface is a corresponding surface of the target object. For a visible surface of any target object, a category of the visible surface may be determined based on multiple confidences, output by the neural network, of the visible surface. For example, it may be determined that the visible surface is a vehicle front-side surface, a vehicle rear-side surface, a vehicle left-side surface or a vehicle right-side surface.

Optionally, image segmentation in the disclosure may be instance segmentation, namely a visible surface of a target object in an image may be obtained by use of an instance segmentation algorithm-based neural network in the disclosure. An instance may be considered as an independent unit. The instance in the disclosure may be considered as a surface of the target object. The instance segmentation algorithm-based neural network includes, but not limited to, Mask Regions with Convolutional Neural Networks (Mask-RCNN). Obtaining a visible surface of a target object by use of a neural network is favorable for improving the accuracy and efficiency of obtaining the visible surface of the target object. In addition, along with the improvement of the accuracy and the processing speed of the neural network, the accuracy and speed of determining an orientation of a target object in the disclosure may also be improved. Moreover, the visible surface of the target object in the image may also be obtained in another manner in the disclosure, and the another manner includes, but not limited to, an edge-detection-based manner, a threshold-segmentation-based manner and a level-set-based manner, etc.

In S110, position information of multiple points in the visible surface in a horizontal plane of a 3D space is acquired.

In an optional example, the 3D space in the disclosure may refer to a 3D space defined by a 3D coordinate system of the photographic device shooting the image. For example, an optical axis direction of the photographic device is a Z-axis direction (i.e., a depth direction) of the 3D space, a horizontal rightward direction is an X-axis direction of the 3D space, and a vertical downward direction is a Y-axis direction of the 3D space, namely the 3D coordinate system of the photographic device is a coordinate system of the 3D space. The horizontal plane in the disclosure usually refers to a plane defined by the Z-axis direction and X-axis direction in the 3D coordinate system. That is, the position information of a point in the horizontal plane of the 3D space usually includes an X coordinate and Z coordinate of the point. It may also be considered that the position information of a point in the horizontal plane of the 3D space refers to a projection position (a position in a top view) of the point in the 3D space on an X0Z plane.

Optionally, the multiple points in the visible surface in the disclosure may refer to points in a points selection region of an effective region of the visible surface. A distance between the points selection region and an edge of the effective region should meet a predetermined distance requirement. For example, a point in the points selection region of the effective region should meet a requirement of the following formula (1). For another example, if a height of the effective region is h1 and a width is w1, a distance between an upper edge of the points selection region of the effective region and an upper edge of the effective region is at least (1/n1)×h1, a distance between a lower edge of the points selection region of the effective region and a lower edge of the effective region is at least (1/n2)×h1, a distance between a left edge of the points selection region of the effective region and a left edge of the effective region is at least (1/n3)×w1, and a distance between a right edge of the points selection region of the effective region and a right edge of the effective region is at least (1/n4)×w1, where n1, n2, n3 and n4 are all integers greater than 1, and values of n1, n2, n3 and n4 may be the same or may also be different.

In the disclosure, the multiple points are limited to be multiple points in the points selection region of the effective region, so that the phenomenon that the position information of the multiple points in the horizontal plane of the 3D space is inaccurate due to the fact that depth information of an edge region is inaccurate may be avoided, improvement of the accuracy of the obtained position information of the multiple points in the horizontal plane of the 3D space is facilitated, and improvement of the accuracy of the finally determined orientation of the target object is further facilitated.

In an optional example, for the target object in the image, when the obtained visible surface of the target object is multiple visible surfaces in the disclosure, one visible surface may be selected from the multiple visible surfaces of the target object as a surface to be processed and position information of multiple points in the surface to be processed in the horizontal plane of the 3D space may be acquired, namely the orientation of the target object is obtained based on a single surface to be processed in the disclosure.

Optionally, one visible surface may be randomly selected from the multiple visible surfaces as the surface to be processed in the disclosure. Optionally, one visible surface may also be selected from the multiple visible surfaces as the surface to be processed based on sizes of the multiple visible surfaces in the disclosure. For example, a visible surface with the largest area may be selected as the surface to be processed. Optionally, one visible surface may also be selected from the multiple visible surfaces as the surface to be processed based on sizes of effective regions of the multiple visible surfaces in the disclosure. Optionally, an area of a visible surface may be determined by the number of points (for example, pixels) in the visible surface. Similarly, an area of an effective region may also be determined by the number of points (for example, pixels) in the effective region. In the disclosure, an effective region of a visible surface may be a region substantially in a vertical plane in the visible surface, the vertical plane being substantially parallel to a Y0Z plane.

In the disclosure, one visible surface may be selected from the multiple visible surfaces, so that the phenomena of high deviation rate and the like of the position information of the multiple points in the horizontal plane of the 3D space due to the fact that a visible region of the visible surface is too small because of occlusion and the like may be avoided, improvement of the accuracy of the obtained position information of the multiple points in the horizontal plane of the 3D space is facilitated, and improvement of the accuracy of the finally determined orientation of the target object is further facilitated.

In an optional example, a process in the disclosure that one visible surface is selected from the multiple visible surfaces as the surface to be processed based on the sizes of the effective regions of the multiple visible surfaces may include the following operations.

In Operation a, for a visible surface, a position box corresponding to the visible surface and configured to select an effective region is determined based on position information of a point (for example, a pixel) in the visible surface in the image.

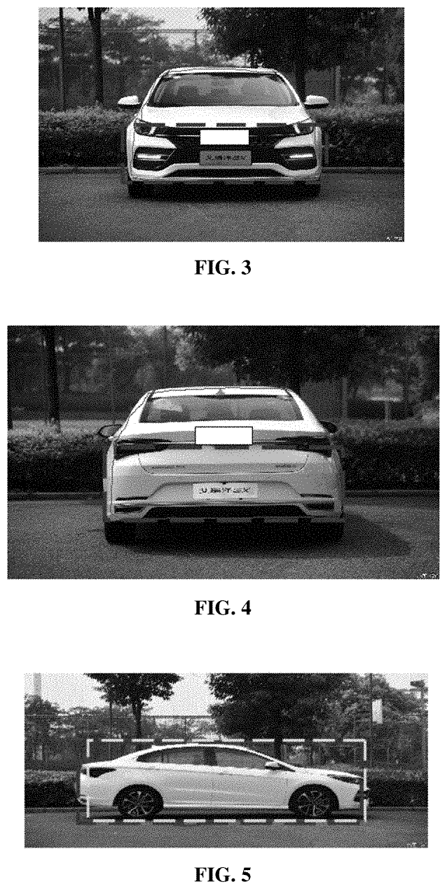

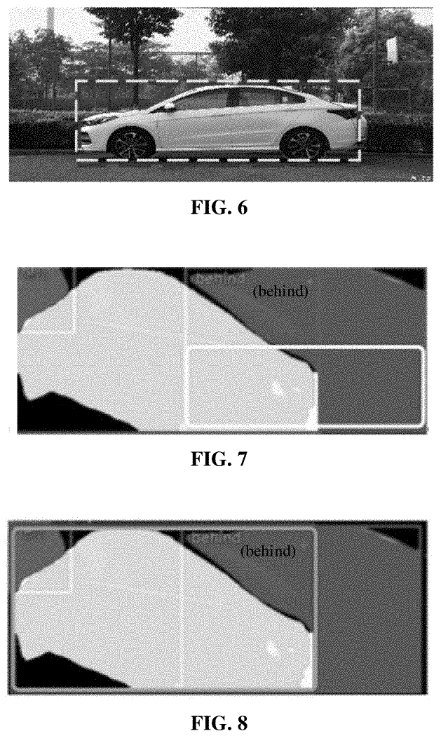

Optionally, the position box configured to select an effective region in the disclosure may at least cover a partial region of the visible surface. The effective region of the visible surface is related to a position of the visible surface. For example, when the visible surface is a vehicle front-side surface, the effective region usually refers to a region formed by a front side of a vehicle headlight and a front side of a vehicle chassis (a region belonging to the vehicle in the dashed box in FIG. 3). For another example, when the visible surface is a vehicle rear-side surface, the effective region usually refers to a region formed by a rear side of a vehicle tail light and a rear side of the vehicle chassis (a region belonging to the vehicle in the dashed box in FIG. 4). For another example, when the visible surface is a vehicle right-side surface, the effective region may refer to the whole visible surface and may also refer to a region formed by right-side surfaces of the vehicle headlight and the vehicle tail light and a right side of the vehicle chassis (a region belonging to the vehicle in the dashed box in FIG. 5). For another example, when the visible surface is a vehicle left-side surface, the effective region may refer to the whole visible surface or may also refer to a region formed by left-side surfaces of the vehicle headlight and the vehicle tail light and a left side of the vehicle chassis (a region belonging to the vehicle in the dashed box in FIG. 6).

In an optional example, no matter whether the effective region of the visible surface is a complete region of the visible surface or the partial region of the visible surface, the effective region of the visible surface may be determined by use of the position box configured to select an effective region in the disclosure. That is, for all visible surfaces in the disclosure, an effective region of each visible surface may be determined by use of a corresponding position box configured to select an effective region, namely the position box may be determined for each visible surface in the disclosure, thereby determining the effective region of each visible surface by use of the position box corresponding to the visible surface.

In another optional example, for part of visible surfaces in the disclosure, the effective regions of the visible surfaces may be determined by use of the position boxes configured to select an effective region. For the other part of visible surfaces, the effective regions of the visible surfaces may be determined in another manner, for example, the whole visible surface is directly determined as the effective region.

Optionally, for a visible surface of a target object, a vertex position of a position box configured to select an effective region and a width and height of the visible surface may be determined based on position information of points (for example, all pixels) in the visible surface in the image in the disclosure. Then, the position box corresponding to the visible surface may be determined based on the vertex position, a part of the width of the visible surface (i.e., a partial width of the visible surface) and a part of the height of the visible surface (i.e., a partial height of the visible surface).

Optionally, when an origin of a coordinate system of the image is at a left lower corner of the image, a minimum x coordinate and a minimum y coordinate in position information of all the pixels in the visible surface in the image may be determined as a vertex (i.e., a left lower vertex) of the position box configured to select an effective region.

Optionally, when the origin of the coordinate system of the image is at a right upper corner of the image, a maximum x coordinate and a maximum y coordinate in the position information of all the pixels in the visible surface in the image may be determined as the vertex (i.e., the left lower vertex) of the position box configured to select an effective region.

Optionally, in the disclosure, a difference between the minimum x coordinate and the maximum x coordinate in the position information of all the pixels in the visible surface in the image may be determined as the width of the visible surface, and a difference between the minimum y coordinate and the maximum y coordinate in the position information of all the pixels in the visible surface in the image may be determined as the height of the visible surface.

Optionally, when the visible surface is a vehicle front-side surface, a position box corresponding to the vehicle front-side surface and configured to select an effective region may be determined based on a vertex (for example, a left lower vertex) of the position box configured to select an effective region, a part of the width of the visible surface (for example, 0.5, 0.35 or 0.6 of the width) and a part of the height of the visible surface (for example, 0.5, 0.35 or 0.6 of the height).

Optionally, when the visible surface is a vehicle rear-side surface, a position box corresponding to the vehicle rear-side surface and configured to select an effective region may be determined based on a vertex (for example, a left lower vertex) of the position box configured to select an effective region, a part of the width of the visible surface (for example, 0.5, 0.35 or 0.6 of the width) and a part of the height of the visible surface (for example, 0.5, 0.35 or 0.6 of the height), as shown by the white rectangle at the right lower corner in FIG. 7.

Optionally, when the visible surface is a vehicle left-side surface, a position box corresponding to the vehicle left-side surface may also be determined based on a vertex position, the width of the visible surface and the height of the visible surface in the disclosure. For example, the position box corresponding to the vehicle left-side surface and configured to select an effective region may be determined based on a vertex (for example, a left lower vertex) of the position box configured to select an effective region, the width of the visible surface and the height of the visible surface.

Optionally, when the visible surface is a vehicle right-side surface, a position box corresponding to the vehicle right-side surface may also be determined based on a vertex of the position box, the width of the visible surface and the height of the visible surface in the disclosure. For example, the position box corresponding to the vehicle right-side surface and configured to select an effective region may be determined based on a vertex (for example, a left lower vertex) of the position box configured to select an effective region, the width of the visible surface and the height of the visible surface, as shown by the light gray rectangle including the vehicle left-side surface in FIG. 8.

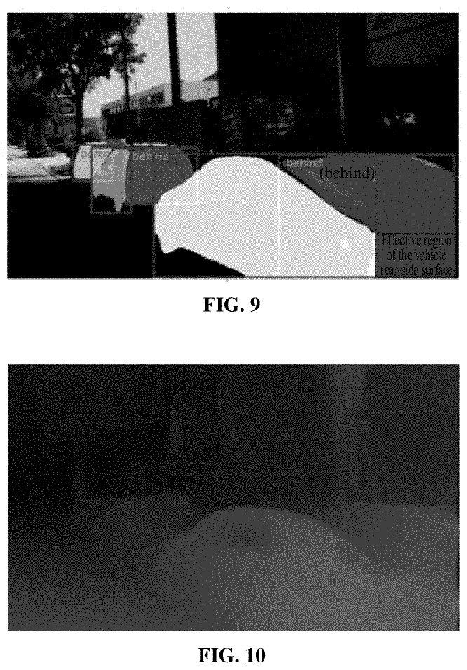

In Operation b, an intersection region of the visible surface and the corresponding position box is determined as the effective region of the visible surface. Optionally, in the disclosure, intersection calculation may be performed on the visible surface and the corresponding position box configured to select an effective region, thereby obtaining a corresponding intersection region. In FIG. 9, the right lower box is an intersection region, i.e., the effective region of the vehicle rear-side surface, obtained by performing intersection calculation on the vehicle rear-side surface.

In Operation c, a visible surface with a largest effective region is determined from multiple visible surfaces as a surface to be processed.

Optionally, for the vehicle left/right-side surface, the whole visible surface may be determined as the effective region, or an intersection region may be determined as the effective region. For the vehicle front/rear-side surface, part of the visible surface is usually determined as the effective region.

In the disclosure, a visible surface with a largest effective region is determined from multiple visible surfaces as the surface to be processed, so that a wider range may be selected when multiple points are selected from the surface to be processed, improvement of the accuracy of the obtained position information of the multiple points in the horizontal plane of the 3D space is facilitated, and improvement of the accuracy of the finally determined orientation of the target object is further facilitated.

In an optional example in the disclosure, for a target object in the image, when an obtained visible surface of the target object is multiple visible surfaces, all the multiple visible surfaces of the target object may be determined as surfaces to be processed and position information of multiple points in each surface to be processed in the horizontal plane of the 3D space may be acquired, namely the orientation of the target object may be obtained based on the multiple surfaces to be processed in the disclosure.

In an optional example, the multiple points may be selected from the effective region of the surface to be processed in the disclosure. For example, the multiple surfaces may be selected from a points selection region of the effective region of the surface to be processed. The points selection region of the effective region refers to a region at a distance meeting a predetermined distance requirement from an edge of the effective region.

For example, a point (for example, a pixel) in the points selection region of the effective region should meet the requirement of the following formula (1):

{(u,v)}={(u,v)|u>u min+∇u [symbol] u<u max−∇u

v>v min+∇v [symbol] v<v max−∇v} Formula (1).

In the formula (1), {(u, v)} represents a set of points in the points selection region of the effective region, (u, v) represents a coordinate of a point (for example, a pixel) in the image, umin represents a minimum u coordinate in points (for example, pixels) in the effective region, umax represents a maximum u coordinate in the points (for example, the pixels) in the effective region, vmin represents a minimum v coordinate in the points (for example, the pixels) in the effective region, and vmax represents a maximum v coordinate in the points (for example, the pixels) in the effective region.

∇u=(u max−u min)×0.25, and ∇v=(v max−v min)×0.10, where 0.25 and 0.10 may be replaced with other decimals.

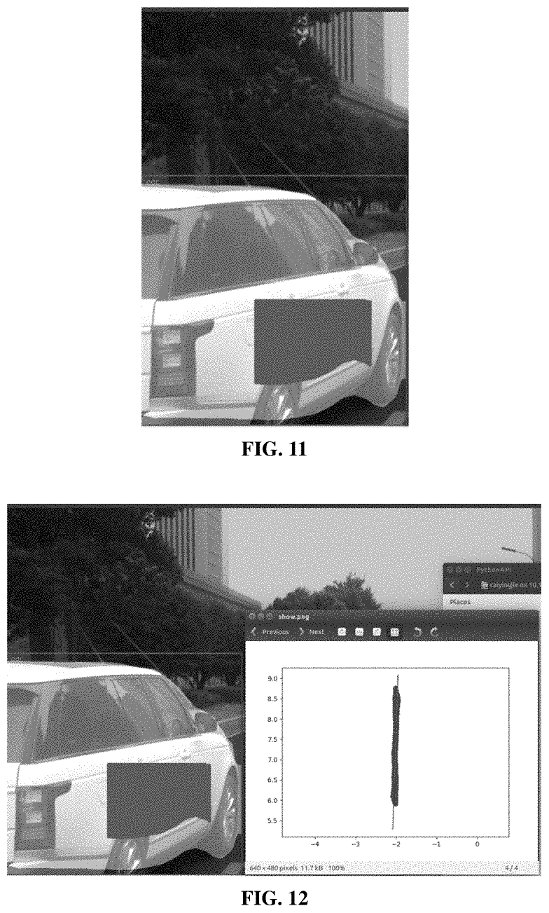

For another example, when a height of the effective region is h2 and a width is w2, a distance between an upper edge of the points selection region of the effective region and an upper edge of the effective region is at least (1/n5)×h2, a distance between a lower edge of the points selection region of the effective region and a lower edge of the effective region is at least (1/n6)×h2, a distance between a left edge of the points selection region of the effective region and a left edge of the effective region is at least (1/n7)×w2, and a distance between a right edge of the points selection region of the effective region and a right edge of the effective region is at least (1/n8)×w2, where n5, n6, n7 and n8 are all integers greater than 1, and values of n5, n6, n7 and n8 may be the same or may also be different. In FIG. 11, the vehicle right-side surface is the effective region of the surface to be processed, and the gray block is the points selection region.

In the disclosure, positions of the multiple points are limited to be the points selection region of the effective region of the visible surface, so that the phenomenon that the position information of the multiple points in the horizontal plane of the 3D space is inaccurate due to the fact that the depth information of the edge region is inaccurate may be avoided, improvement of the accuracy of the obtained position information of the multiple points in the horizontal plane of the 3D space is facilitated, and improvement of the accuracy of the finally determined orientation of the target object is further facilitated.

In an optional example, in the disclosure, Z coordinates of multiple points may be acquired at first, and then X coordinates and Y coordinates of the multiple points may be acquired by use of the following formula (2):

P*[X,Y,Z]^{T}=w*[u,v,1]^{T} Formula (2).

In the formula (2), P is a known parameter and is an intrinsic parameter of the photographic device, and P may be a 3×3 matrix, namely

$$( \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ) ;$$

both a₁₁ and a₁₂ represent a focal length of the photographic device; a₁₃ represents an optical center of the photographic device on an x coordinate axis of the image; a₂₃ represents an optical center of the photographic device on a y coordinate axis of the image, values of all the other parameters in the matrix are 0; X, Y and Z represent the X coordinate, Y coordinate and Z coordinate of the point in the 3D space; w represents a scaling transform ratio, a value of w may be a value of Z; u and v represent coordinates of the point in the image; and [*]^{T} represents a transposed matrix of *.

P may be put into the formula (2) to obtain the following formula (3):

$$\{ \begin{matrix}{a}_{11} * X + {a}_{12} * Y + {a}_{13} * Z = w * u \\ {a}_{21} * X + {a}_{22} * Y + {a}_{23} * Z = w * u \\ {a}_{31} * X + {a}_{32} * Y + {a}_{33} * Z = w\end{matrix} \} . \qquad Formula ( 3 )$$

In the disclosure, u, v and z of the multiple points are known values, so that X and Y of the multiple points may be obtained by use of the formula (3). In such a manner, the position information, i.e., X and Z, of the multiple points in the horizontal plane of the 3D space may be obtained, namely position information of the points in the top view after the points in the image are converted to the 3D space is obtained.

In an optional example in the disclosure, the Z coordinates of the multiple points may be obtained in the following manner. At first, depth information (for example, a depth map) of the image is obtained. The depth map and the image are usually the same in size, and a gray value at a position of each pixel in the depth map represents a depth value of a point (for example, a pixel) at the position in the image. An example of the depth map is shown in FIG. 10. Then, the Z coordinates of the multiple points may be obtained by use of the depth information of the image.

Optionally, in the disclosure, the depth information of the image may be obtained in, but not limited to, the following manners: the depth information of the image is obtained by a neural network, the depth information of the image is obtained by an RGB-Depth (RGB-D)-based photographic device, or the depth information of the image is obtained by a Lidar device.

For example, an image may be input to a neural network, and the neural network may perform depth prediction and output a depth map the same as the input image in size. A structure of the neural network includes, but not limited to, a Fully Convolutional Network (FCN) and the like. The neural network can be successfully trained based on image samples with depth labels.

For another example, an image may be input to another neural network, and the neural network may perform binocular parallax prediction processing and output parallax information of the image. Then, depth information may be obtained by use of a parallax in the disclosure. For example, the depth information of the image may be obtained by use of the following formula (4):

$$z = \frac{d * f}{b} . \qquad Formula ( 4 )$$

In the formula (4), z represents a depth of a pixel; d represents a parallax, output by the neural network, of the pixel; f represents a focal length of the photographic device and is a known value; and b represents is a distance of a binocular camera and is a known value.

For another example, after point cloud data is obtained by a Lidar, the depth information of the image may be obtained by use of a formula for conversion of a coordinate system of the Lidar to an image plane.

In S120, an orientation of the target object is determined based on the position information.

In an optional example, straight line fitting may be performed based on X and Z of the multiple points in the disclosure. For example, a projection condition of multiple points in the gray block in FIG. 12 in the X0Z plane is shown as the thick vertical line (formed by the points) in the right lower corner in FIG. 12, and a straight line fitting result of these points is the thin straight line in the right lower corner in FIG. 12. In the disclosure, the orientation of the target object may be determined based on a slope of a straight line obtained by fitting. For example, when straight line fitting is performed on multiple points on the vehicle left/right-side surface, a slope of a straight line obtained by fitting may be directly determined as an orientation of the vehicle. For another example, when straight line fitting is performed on multiple points on the vehicle front/rear-side surface, a slope of a straight line obtained by fitting may be regulated by π/4 or π/2, thereby obtaining the orientation of the vehicle. A manner for straight line fitting in the disclosure includes, but not limited to, linear curve fitting or linear-function least-square fitting, etc.

In an existing manner of obtaining an orientation of a target object based on classification and regression of a neural network, for obtaining the orientation of the target object more accurately, when the neural network is trained, the number of orientation classes is required to be increased, which may not only increase the difficulties in labeling samples for training but also increase the difficulties in training convergence of the neural network. However, if the neural network is trained only based on four classes or eight classes, the determined orientation of the target object is not so accurate. Consequently, the existing manner of obtaining the orientation of the target object based on classification and regression of the neural network is unlikely to reach a balance between the difficulties in training of the neural network and the accuracy of the determined orientation. In the disclosure, the orientation of the vehicle may be determined based on the multiple points on the visible surface of the target object, which may not only balance the difficulties in training and the accuracy of the determined orientation but also ensure that the orientation of the target object is any angle in a range of 0 to 2π, so that not only the difficulties in determining the orientation of the target object are reduced, but also the accuracy of the obtained orientation of the target object (for example, the vehicle) is enhanced. In addition, few computing resources are occupied by a straight line fitting process in the disclosure, so that the orientation of the target object may be determined rapidly, and the real-time performance of determining the orientation of the target object is improved. Moreover, development of a surface-based semantic segmentation technology and a depth determination technology is favorable for improving the accuracy of determining the orientation of the target object in the disclosure.

In an optional example, when the orientation of the target object is determined based on multiple visible surfaces in the disclosure, for each visible surface, straight line fitting may be performed based on position information of multiple points in each visible surface in the horizontal plane of the 3D space to obtain multiple straight lines in the disclosure, and an orientation of the target object may be determined based on slopes of the multiple straight lines. For example, the orientation of the target object may be determined based on a slope of one straight line in the multiple straight lines. For another example, multiple orientations of the target object may be determined based on the slopes of the multiple straight lines respectively, and then weighted averaging may be performed on the multiple orientations based on a balance factor of each orientation to obtain a final orientation of the target object. The balance factor may be a preset known value. Herein, presetting may be dynamic setting. That is, when the balance factor is set, multiple factors of the visible surface of the target object in the image may be considered, for example, whether the visible surface of the target object in the image is a complete surface or not; and for another example, whether the visible surface of the target object in the image is the vehicle front/rear-side surface or the vehicle left/right-side surface.

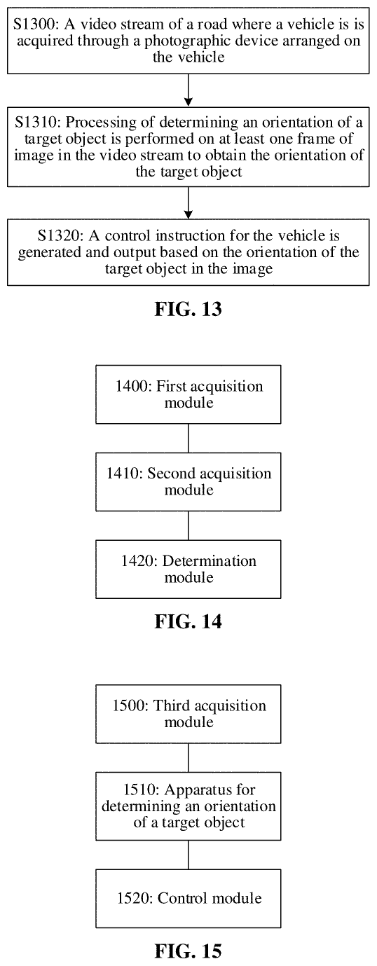

FIG. 13 is a flowchart of an embodiment of a method for controlling intelligent driving according to the disclosure. The method for controlling intelligent driving of the disclosure may be applied, but not limited, to a piloted driving (for example, completely unmanned piloted driving) environment or an aided driving environment.

001011 In S1300, a video stream of a road where a vehicle is acquired through a photographic device arranged on a vehicle. The photographic device includes, but not limited to, an RGB-based photographic device, etc.

001021 In 51310, processing of determining an orientation of a target object is performed on at least one frame of image in the video stream to obtain the orientation of the target object. A specific implementation process of the operations may refer to the descriptions for FIG. 1 in the method implementation modes and will not be described herein in detail.

In S1320, a control instruction for the vehicle is generated and output based on the orientation of the target object in the image.

Optionally, the control instruction generated in the disclosure includes, but not limited to, a control instruction for speed keeping, a control instruction for speed regulation (for example, a deceleration running instruction and an acceleration running instruction), a control instruction for direction keeping, a control instruction for direction regulation (for example, a turn-left instruction, a turn-right instruction, an instruction of merging to a left-side lane or an instruction of merging to a right-side lane), a honking instruction, a control instruction for alarm prompting, a control instruction for driving mode switching (for example, switching to an auto cruise driving mode), an instruction for path planning or an instruction for trajectory tracking.

It is to be particularly noted that the target object orientation determination technology of the disclosure may be not only applied to the field of intelligent driving control but also applied to other fields. For example, target object orientation detection in industrial manufacturing, target object orientation detection in an indoor environment such as a supermarket and target object orientation detection in the field of security protection may be implemented. Application scenarios of the target object orientation determination technology are not limited in the disclosure.

An example of an apparatus for determining an orientation of a target object provided in the disclosure is shown in FIG. 14. The apparatus in FIG. 14 includes a first acquisition module 1400, a second acquisition module 1410 and a determination module 1420.

The first acquisition module 1400 is configured to acquire a visible surface of a target object in an image. For example, a visible surface of a vehicle that is the target object in the image is acquired.

Optionally, the image may be a video frame in a video shot by a photographic device arranged on a movable object, or may also be a video frame in a video shot by a photographic device arranged at a fixed position. When the target object is a vehicle, the target object may include a vehicle front-side surface including a front side of a vehicle roof, a front side of a vehicle headlight and a front side of a vehicle chassis; a vehicle rear-side surface including a rear side of the vehicle roof, a rear side of a vehicle tail light and a rear side of the vehicle chassis; a vehicle left-side surface including a left side of the vehicle roof, left-side surfaces of the vehicle headlight and the vehicle tail light, a left side of the vehicle chassis and vehicle left-side tires; and a vehicle right-side surface including a right side of the vehicle roof, right-side surfaces of the vehicle headlight and the vehicle tail light, a right side of the vehicle chassis and vehicle right-side tires. The first acquisition module 1400 may further be configured to perform image segmentation on the image and obtain the visible surface of the target object in the image based on an image segmentation result. The operations specifically executed by the first acquisition module 1400 may refer to the descriptions for S100 and will not be described herein in detail.

The second acquisition module 1410 is configured to acquire position information of multiple points in the visible surface in a horizontal plane of a 3D space. The second acquisition module 1410 may include a first submodule and a second submodule. The first submodule is configured to, when the number of the visible surface is multiple, select one visible surface from the multiple visible surfaces as a surface to be processed. The second submodule is configured to acquire position information of multiple points in the surface to be processed in the horizontal plane of the 3D space.

Optionally, the first submodule may include any one of: a first unit, a second unit and a third unit. The first unit is configured to randomly select one visible surface from the multiple visible surfaces as the surface to be processed. The second unit is configured to select one visible surface from the multiple visible surfaces as the surface to be processed based on sizes of the multiple visible surfaces. The third unit is configured to select one visible surface from the multiple visible surfaces as the surface to be processed based on sizes of effective regions of the multiple visible surfaces. The effective region of the visible surface may include a complete region of the visible surface, and may also include a partial region of the visible surface. An effective region of the vehicle left/right-side surface may include a complete region of the visible surface. An effective region of the vehicle front/rear-side surface includes a partial region of the visible surface. The third unit may include a first subunit, a second subunit and a third subunit. The first subunit is configured to determine each position box respectively corresponding to each visible surface and configured to select an effective region based on position information of a point in each visible surface in the image. The second subunit is configured to determine an intersection region of each visible surface and each position box as an effective region of each visible surface. The third subunit is configured to determine a visible surface with a largest effective region from the multiple visible surfaces as the surface to be processed. The first subunit may determine a vertex position of a position box configured to select an effective region and a width and height of a visible surface at first based on position information of a point in the visible surface in the image. Then, the first subunit may determine the position box corresponding to the visible surface based on the vertex position, a part of the width and a part of the height of the visible surface. The vertex position of the position box may include a position obtained based on a minimum x coordinate and a minimum y coordinate in position information of multiple points in the visible surface in the image. The second submodule may include a fourth unit and a fifth unit. The fourth unit is configured to select multiple points from the effective region of the surface to be processed. The fifth unit is configured to acquire position information of the multiple points in the horizontal plane of the 3D space. The fourth unit may select the multiple points from a points selection region of the effective region of the surface to be processed. Herein, the points selection region may include a region at a distance meeting a predetermined distance requirement from an edge of the effective region.

Optionally, the second acquisition module 1410 may include a third submodule. The third submodule is configured to, when the number of the visible surface is multiple, acquire position information of multiple points in the multiple visible surfaces in the horizontal plane of the 3D space respectively. The second submodule or the third submodule may acquire the position information of the multiple points in the horizontal plane of the 3D space in a manner of acquiring depth information of the multiple points at first and then obtaining position information of the multiple points on a horizontal coordinate axis in the horizontal plane of the 3D space based on the depth information and coordinates of the multiple points in the image. For example, the second submodule or the third submodule may input the image to a first neural network, the first neural network may perform depth processing, and the depth information of the multiple points may be obtained based on an output of the first neural network. For another example, the second submodule or the third submodule may input the image to a second neural network, the second neural network may perform parallax processing, and the depth information of the multiple points may be obtained based on a parallax output by the second neural network. For another example, the second submodule or the third submodule may obtain the depth information of the multiple points based on a depth image shot by a depth photographic device. For another example, the second submodule or the third submodule may obtain the depth information of the multiple points based on point cloud data obtained by a Lidar device.

The operations specifically executed by the second acquisition module 1410 may refer to the descriptions for S110 and will not be described herein in detail.

The determination module 1420 is configured to determine an orientation of the target object based on the position information acquired by the second acquisition module 1410. The determination module 1420 may perform straight line fitting at first based on the position information of the multiple points in the surface to be processed in the horizontal plane of the 3D space. Then, the determination module 1420 may determine the orientation of the target object based on a slope of a straight line obtained by fitting. The determination module 1420 may include a fourth submodule and a fifth submodule. The fourth submodule is configured to perform straight line fitting based on the position information of the multiple points in the multiple visible surfaces in the horizontal plane of the 3D space respectively. The fifth submodule is configured to determine the orientation of the target object based on slopes of multiple straight lines obtained by fitting. For example, the fifth submodule may determine the orientation of the target object based on the slope of one straight line in the multiple straight lines. For another example, the fifth submodule may determine multiple orientations of the target object based on the slopes of the multiple straight lines and determine a final orientation of the target object based on the multiple orientations and a balance factor of the multiple orientations. The operations specifically executed by the determination module 1420 may refer to the descriptions for S120 and will not be described herein in detail.

A structure of an apparatus for controlling intelligent driving provided in the disclosure is shown in FIG. 15.

The apparatus in FIG. 15 includes a third acquisition module 1500, an apparatus 1510 for determining an orientation of a target object and a control module 1520. The third acquisition module 1510 is configured to acquire a video stream of a road where a vehicle is through a photographic device arranged on the vehicle. The apparatus 1510 for determining an orientation of a target object is configured to perform processing of determining an orientation of a target object on at least one video frame in the video stream to obtain the orientation of the target object. The control module 1520 is configured to generate and output a control instruction for the vehicle based on the orientation of the target object. For example, the control instruction generated and output by the control module 1520 may include a control instruction for speed keeping, a control instruction for speed regulation, a control instruction for direction keeping, a control instruction for direction regulation, a control instruction for alarm prompting, a control instruction for driving mode switching, an instruction for path planning or an instruction for trajectory tracking.

Exemplary Device

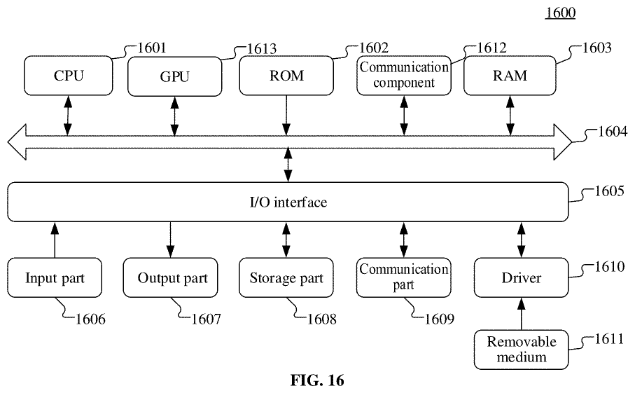

FIG. 16 illustrates an exemplary device 1600 for implementing the disclosure. The device 1600 may be a control system/electronic system configured in an automobile, a mobile terminal (for example, a smart mobile phone), a PC (for example, a desktop computer or a notebook computer), a tablet computer and a server, etc. In FIG. 16, the device 1600 includes one or more processors, a communication component and the like. The one or more processors may be one or more Central Processing Units (CPUs) 1601 and/or one or more Graphics Processing Units (GPUs) 1613 configured to perform visual tracking by use of a neural network, etc. The processor may execute various proper actions and processing according to an executable instruction stored in a Read-Only Memory (ROM) 1602 or an executable instruction loaded from a storage part 1608 to a Random Access Memory (RAM) 1603. The communication component 1612 may include, but not limited to, a network card. The network card may include, but not limited to, an Infiniband (IB) network card. The processor may communicate with the ROM 1602 and/or the RAM 1603 to execute the executable instruction, is connected with the communication component 1612 through a bus 1604 and communicates with another target device through the communication component 1612, thereby completing the corresponding operations in the disclosure.

001181 The operation executed according to each instruction may refer to the related descriptions in the method embodiments and will not be described herein in detail. In addition, various programs and data required by the operations of the device may further be stored in the RAM 1603. The CPU 1601, the ROM 1602 and the RAM 1603 are connected with one another through a bus 1604. When there is the RAM 1603, the ROM 1602 is an optional module. The RAM 1603 may store the executable instruction, or the executable instruction are written in the ROM 1602 during running, and through the executable instruction, the CPU 1601 executes the operations of the method for determining an orientation of a target object or the method for controlling intelligent driving. An Input/Output (I/O) interface 1605 is also connected to the bus 1604. The communication component 1612 may be integrated, or may also be arranged to include multiple submodules (for example, multiple IB network cards) connected with the bus respectively.

The following components may be connected to the I/O interface 1605: an input part 1606 including a keyboard, a mouse and the like; an output part 1607 including a Cathode-Ray Tube (CRT), a Liquid Crystal Display (LCD), a speaker and the like; the storage part 1608 including a hard disk and the like; and a communication part 1609 including a Local Area Network (LAN) card and a network interface card of a modem and the like. The communication part 1609 may execute communication processing through a network such as the Internet. A driver 1610 may be also connected to the I/O interface 1605 as required. A removable medium 1611, for example, a magnetic disk, an optical disk, a magneto-optical disk and a semiconductor memory, is installed on the driver 1610 as required such that a computer program read therefrom is installed in the storage part 1608 as required.

It is to be particularly noted that the architecture shown in FIG. 16 is only an optional implementation mode and the number and types of the components in FIG. 16 may be selected, deleted, added or replaced according to a practical requirement in a specific practice process. In terms of arrangement of different functional components, an implementation manner such as separate arrangement or integrated arrangement may also be adopted. For example, the GPU 1613 and the CPU 1601 may be separately arranged. For another example, the GPU 1613 may be integrated to the CPU 1601, and the communication component may be separately arranged or may also be integrated to the CPU 1601 or the GPU 1613. All these alternative implementation modes shall fall within the scope of protection disclosed in the disclosure.

Particularly, according to the implementation mode of the disclosure, the process described below with reference to the flowchart may be implemented as a computer software program. For example, the implementation mode of the disclosure includes a computer program product, which includes a computer program physically included in a machine-readable medium, the computer program includes a program code configured to execute the operations shown in the flowchart, and the program code may include instructions corresponding to the operations in the method provided in the disclosure. In this implementation mode, the computer program may be downloaded from a network and installed through the communication part 1609 and/or installed from the removable medium 1611. The computer program may be executed by the CPU 1601 to execute the instructions for implementing corresponding operations in the disclosure.

In one or more optional implementation modes, the embodiment of the disclosure also provides a computer program product, which is configured to store computer-readable instruction, the instruction being executed to enable a computer to execute the method for determining an orientation of a target object or method for controlling intelligent driving in any abovementioned embodiment. The computer program product may specifically be implemented through hardware, software or a combination thereof. In an optional example, the computer program product is specifically embodied as a computer storage medium. In another optional example, the computer program product is specifically embodied as a software product, for example, a Software Development Kit (SDK).

In one or more optional implementation modes, the embodiments of the disclosure also provide another method for determining an orientation of a target object and method for controlling intelligent driving, as well as corresponding apparatuses, an electronic device, a computer storage medium, a computer program and a computer program product. The method includes that: a first apparatus sends a target object orientation determination instruction or an intelligent driving control instruction to a second apparatus, the instruction enabling the second apparatus to execute the method for determining an orientation of a target object or method for controlling intelligent driving in any abovementioned possible embodiment; and the first apparatus receives a target object orientation determination result or an intelligent driving control result from the second apparatus.

In some embodiments, the target object orientation determination instruction or the intelligent driving control instruction may specifically be a calling instruction. The first apparatus may instruct the second apparatus in a calling manner to execute a target object orientation determination operation or an intelligent driving control operation. Correspondingly, the second apparatus, responsive to receiving the calling instruction, may execute the operations and/or flows in any embodiment of the method for determining an orientation of a target object or the method for controlling intelligent driving.

According to another aspect of the implementation modes of the disclosure, an electronic device is provided, which includes: a memory, configured to store a computer program; and a processor, configured to execute the computer program stored in the memory, the computer program being executed to implement any method implementation mode of the disclosure. According to another aspect of the implementation modes of the disclosure, a computer-readable storage medium is provided, in which a computer program is stored, the computer program being executed by a processor to implement any method implementation mode of the disclosure. According to another aspect of the implementation modes of the disclosure, a computer program is provided, which includes computer instructions, the computer instructions running in a processor of a device to implement any method implementation mode of the disclosure.

Based on the method and apparatus for determining an orientation of a target object, the method and apparatus for controlling intelligent driving, the electronic device, the computer-readable storage medium and the computer program in the disclosure, an orientation of a target object may be determined by fitting based on position information of multiple points in a visible surface of the target object in an image in a horizontal plane of a 3D space, so that the problems of low accuracy of an orientation predicted by a neural network for orientation classification and complexity in training of the neural network directly regressing an orientation angle value in an implementation manner that orientation classification is performed through the neural network to obtain the orientation of the target object may be effectively solved, and the orientation of the target object may be obtained rapidly and accurately. It can be seen that the technical solutions provided in the disclosure are favorable for improving the accuracy of the obtained orientation of the target object and also favorable for improving the real-time performance of obtaining the orientation of the target object.

It is to be understood that terms “first”, “second” and the like in the embodiment of the disclosure are only adopted for distinguishing and should not be understood as limits to the embodiment of the disclosure. It is also to be understood that, in the disclosure, “multiple” may refer to two or more than two and “at least one” may refer to one, two or more than two. It is also to be understood that, for any component, data or structure mentioned in the disclosure, the number thereof can be understood to be one or multiple if there is no specific limits or opposite revelations are presented in the context. It is also to be understood that, in the disclosure, the descriptions about each embodiment are made with emphasis on differences between each embodiment and the same or similar parts may refer to each other and will not be elaborated for simplicity.

The method, apparatus, electronic device and computer-readable storage medium of the disclosure may be implemented in many manners. For example, the method, apparatus, electronic device and computer-readable storage medium of the disclosure may be implemented through software, hardware, firmware or any combination of the software, the hardware and the firmware. The sequence of the operations of the method is only for description, and the operations of the method of the disclosure are not limited to the sequence specifically described above, unless otherwise specified in another manner. In addition, in some implementation modes, the disclosure may also be implemented as a program recorded in a recording medium, and the program includes a machine-readable instruction configured to implement the method according to the disclosure. Therefore, the disclosure further covers the recording medium storing the program configured to execute the method according to the disclosure.

The descriptions of the disclosure are made for examples and description and are not exhaustive or intended to limit the disclosure to the disclosed form. Many modifications and variations are apparent to those of ordinary skill in the art. The implementation modes are selected and described to describe the principle and practical application of the disclosure better and enable those of ordinary skill in the art to understand the embodiment of the disclosure and further design various implementation modes suitable for specific purposes and with various modifications.

1. A method for determining an orientation of a target object, comprising:
acquiring a visible surface of a target object in an image;
acquiring position information of multiple points in the visible surface in a horizontal plane of a three-dimensional (3D) space; and
determining an orientation of the target object based on the position information.

2. The method of claim 1, wherein the target object comprises a vehicle, and the target object comprises at least one of following surfaces:
a vehicle front-side surface comprising a front side of a vehicle roof, a front side of a vehicle headlight and a front side of a vehicle chassis;
a vehicle rear-side surface comprising a rear side of the vehicle roof, a rear side of a vehicle tail light and a rear side of the vehicle chassis;
a vehicle left-side surface comprising a left side of the vehicle roof, left-side surfaces of the vehicle headlight and the vehicle tail light, a left side of the vehicle chassis and vehicle left-side tires; and
a vehicle right-side surface comprising a right side of the vehicle roof, right-side surfaces of the vehicle headlight and the vehicle tail light, a right side of the vehicle chassis and vehicle right-side tires.

3. The method of claim 1, wherein the image comprises:
a video frame in a video shot by a photographic device arranged on a movable object; or
a video frame in a video shot by a photographic device arranged at a fixed position.

4. The method of claim 1, wherein acquiring the visible surface of the target object in the image comprises:
performing image segmentation on the image; and
obtaining the visible surface of the target object in the image based on an image segmentation result.

5. The method of claim 1, wherein acquiring the position information of the multiple points in the visible surface in the horizontal plane of the 3D space comprises:
when the number of the visible surface is multiple, selecting one visible surface from multiple visible surfaces as a surface to be processed; and
acquiring position information of multiple points in the surface to be processed in the horizontal plane of the 3D space.

6. The method of claim 5, wherein selecting one visible surface from the multiple visible surfaces as the surface to be processed comprises:
randomly selecting one visible surface from the multiple visible surfaces as the surface to be processed; or
selecting one visible surface from the multiple visible surfaces as the surface to be processed based on sizes of the multiple visible surfaces; or
selecting one visible surface from the multiple visible surfaces as the surface to be processed based on sizes of effective regions of the multiple visible surfaces,
wherein the effective region of the visible surface comprises a complete region of the visible surface or a partial region of the visible surface;
wherein an effective region of the vehicle left/right-side surface comprises the complete region of the visible surface; and
an effective region of the vehicle front/rear-side surface comprises the partial region of the visible surface.

7. The method of claim 6, wherein selecting one visible surface from the multiple visible surfaces as the surface to be processed based on the sizes of the effective regions of the multiple visible surfaces comprises:
determining each position box respectively corresponding to each visible surface and configured to select an effective region based on position information of a point in each visible surface in the image;
determining an intersection region of each visible surface and each position box as an effective region of each visible surface; and
determining a visible surface with a largest effective region from the multiple visible surfaces as the surface to be processed.

8. The method of claim 7, wherein determining each position box respectively corresponding to each visible surface and configured to select an effective region based on the position information of the point in each visible surface in the image comprises:
determining a vertex position of a position box configured to select an effective region and a width and height of a visible surface based on position information of a point in the visible surface in the image; and
determining the position box corresponding to the visible surface based on the vertex position, a part of the width and a part of the height of the visible surface.

9. The method of claim 8, wherein the vertex position of the position box comprises a position obtained based on a minimum x coordinate and a minimum y coordinate in position information of multiple points in the visible surface in the image.

10. The method of claim 5, wherein acquiring the position information of the multiple points in the surface to be processed in the horizontal plane of the 3D space comprises:
selecting multiple points from an effective region of the surface to be processed; and
acquiring position information of the multiple points in the horizontal plane of the 3D space.

11. The method of claim 10, wherein selecting the multiple points from the effective region of the surface to be processed comprises:
selecting the multiple points from a points selection region of the effective region of the surface to be processed, the points selection region comprising a region at a distance meeting a predetermined distance requirement from an edge of the effective region.

12. The method of claim 5, wherein determining the orientation of the target object based on the position information comprises:
performing straight line fitting based on the position information of the multiple points in the surface to be processed in the horizontal plane of the 3D space; and
determining the orientation of the target object based on a slope of a straight line obtained by fitting.

13. The method of claim 1, wherein
acquiring the position information of the multiple points in the visible surface in the horizontal plane of the 3D space comprises:
when the number of the visible surface is multiple, acquiring position information of multiple points in the multiple visible surfaces in the horizontal plane of the 3D space respectively; and
determining the orientation of the target object based on the position information comprises:
performing straight line fitting based on the position information of the multiple points in the multiple visible surfaces in the horizontal plane of the 3D space respectively, and
determining the orientation of the target object based on slopes of multiple straight lines obtained by fitting.

14. The method of claim 13, wherein determining the orientation of the target object based on the slopes of the multiple straight lines obtained by fitting comprises:
determining the orientation of the target object based on the slope of one straight line in the multiple straight lines; or
determining multiple orientations of the target object based on the slopes of the multiple straight lines, and determining a final orientation of the target object based on the multiple orientations and a balance factor of the multiple orientations.

15. The method of claim 5 wherein acquiring the position information of the multiple points in the horizontal plane of the 3D space comprises:
acquiring depth information of the multiple points; and
obtaining position information of the multiple points on a horizontal coordinate axis in the horizontal plane of the 3D space based on the depth information and coordinates of the multiple points in the image.

16. The method of claim 15, wherein the depth information of the multiple points is acquired in any one of following manners:
inputting the image to a first neural network, performing depth processing through the first neural network, and obtaining the depth information of the multiple points based on an output of the first neural network;
inputting the image to a second neural network, performing parallax processing through the second neural network, and obtaining the depth information of the multiple points based on a parallax output by the second neural network;
obtaining the depth information of the multiple points based on a depth image shot by a depth photographic device; and
obtaining the depth information of the multiple points based on point cloud data obtained by a Lidar device.

17. A method for controlling intelligent driving, comprising:
acquiring a video stream of a road where a vehicle is through a photographic device arranged on the vehicle;
acquiring a visible surface of a target object in an image;
acquiring position information of multiple points in the visible surface in a horizontal plane of a three-dimensional (3D) space;
determining an orientation of the target object based on the position information; and
generating and outputting a control instruction for the vehicle based on the orientation of the target object.

18. An apparatus for determining an orientation of a target object, comprising:
a processor; and
a memory configured to store instructions executable by the processor,
wherein the processor is configured to:
acquire a visible surface of a target object in an image;
acquire position information of multiple points in the visible surface in a horizontal plane of a Three-Dimensional (3D) space; and
determine an orientation of the target object based on the position information.

19. An apparatus for controlling intelligent driving, comprising the apparatus of claim 18 and a controller;
wherein the processor is configured to:
acquire a video stream of a road where a vehicle is through a photographic device arranged on the vehicle; and
perform processing of determining an orientation of a target object on at least one video frame in the video stream to obtain the orientation of the target object; and
the controller is configured to generate and output a control instruction for the vehicle based on the orientation of the target object.

20. A computer-readable storage medium, in which a computer program is stored that, when executed by a processor, implements the method of claim 1.
